(19) United States
(12) Patent Application Publication
(10) Pub. No.: US 2014/0330901 A1
(43) Pub. Date: Nov. 6, 2014

(54) METHOD AND DEVICE FOR SHARING DIGITAL OBJECT OVER MESH NETWORK

(71) Applicant: HTC CORPORATION, Taoyuan County (TW)

(72) Inventors: Edward Chang, Taoyuan County (TW); Te-Chuan Liu, Taoyuan County (TW); Zih-Ci Lin, Taoyuan County (TW); Yi-Yu Chung, Taoyuan County (TW)

(73) Assignee: HTC Corporation, Taoyuan County (TW)

(21) Appl. No.: 13/886,272

(22) Filed: May 3, 2013

(51) Int. Cl. H04L 29/08

(52) U.S. Cl. CPC H04L 67/06
USPC 709/204

(57) ABSTRACT

A method for sharing a digital object over a mesh network is provided in the present invention. The mesh network includes a group owner and a plurality of target devices, and the method is executed by the group owner. The method includes the following steps. First, a table including metadata information is constructed, wherein the metadata information includes an original source of the digital object in the mesh network. Next, the table is distributed to each of the target devices, wherein each of the target devices may downloads the digital object according to the metadata information. The table is updated according to a change of a status of the target devices. Then, the updated table is distributed to each of the target devices. An electronic device is further provided in the present invention so as to embody the aforementioned method.

### BACKGROUND OF THE INVENTION

1. Field of the Invention

The present invention generally relates to a method and a device for sharing a digital object. In particular, the present invention relates to a method and a device for sharing a digital object over a mesh network.

2. Description of Related Art

With the advent of more robust electronics, electronic devices have become more prevalent. A mobile communication device such as a smart phone has shown a tremendous growth and has been considered as one of the most prominent technologies in recent years. As mobile communication devices have become increasingly versatile, in addition to voice communication, such devices may further provide functions such as video conferencing, web browsing, music listening, video watching, game applications, and so forth. Since the mobile communication devices include advanced Internet capabilities as well as large memory storages, many features which were only limited before to computers have become available in the mobile communication devices. Hence, users may wish to exchange information such as music, video clips, photographs, and games with a social group such as family members, friends, or colleagues anytime and anywhere.

File sharing among mobile communication devices may be achieved by a direct and robust connection to a centralized device which provides the file. In real-life application, such procedure may be complicated due to a number of mitigating factors including available bandwidth of cellular network which limits the effectiveness and overall reliability for delivering large files or time-sensitive data files.

On the other hand, file sharing among mobile communication devices may also be achieved by peer-to-peer (P2P) connections. The devices in a P2P network are equally privileged participants sharing a portion of their resources. However, several factors may adversely impact the performance and cost associated with a conventional P2P technology. For example, significant processing power and memory bandwidth may be consumed to maintain links to other devices participating in the P2P network.

Accordingly, there could be a demand to develop tools to optimize the speed of file transfer among the mobile communication devices over a network with limited bandwidth as well as to offload the traffic from an original content distributor within the network.

### SUMMARY OF THE INVENTION

The present invention is directed to a method and a device for sharing a digital object over a mesh network efficiently.

According to an embodiment of the present invention, a method for sharing a digital object over a mesh network is provided. The mesh network includes a group owner and a plurality of target devices, wherein the method is executed by the group owner. The method includes the following steps. First, a table including metadata information is constructed, wherein the metadata information includes an original source of the digital object in the mesh network. Next, the table is distributed to each of the target devices, wherein each of the target devices downloads the digital object according to the metadata information. The table is updated according to changes of status of the target devices of the target devices. Then, the updated table is distributed to each of the target devices.

According to an embodiment of the present invention, a method for sharing a digital object over a mesh network is provided. The mesh network includes a group owner and a plurality of target devices, wherein the method is executed by a first target device of the target devices. The method includes the following steps. First, a table is received from the group owner. The table includes metadata information, and the metadata information includes an original source of the digital object in the mesh network. Next, the digital object is downloaded from an alternative source when the metadata information further includes the alternative source. The alternative source is a second target device of the target devices or a source in an external network. Then, the digital object is downloaded from the original source when the metadata information does not include the alternative source.

According to an embodiment of the present invention, an electronic device for sharing a digital object over a mesh network is provided. The mesh network includes the electronic device and a plurality of target devices, wherein the electronic device includes a processor and a network module. The processor constructs a table including metadata information and updates the table according to changes of status of the target devices, wherein the metadata information includes an original source of the digital object in the mesh network. The network module, coupled to the processor, distributes the constructed table and the updated table to each of the target devices, wherein each of the target devices downloads the digital object according to the metadata information.

According to an embodiment of the present invention, an electronic device for sharing a digital object over a mesh network is provided. The mesh network includes the group owner and a plurality of target devices, wherein the electronic device is one of the target devices and the electronic device includes a network module and a processor. The processor, coupled to the network module, receives a table from the group owner through the network module. The table includes metadata information, and the metadata information includes an original source of the digital object in the mesh network. The processor downloads the digital object from an alternative source through the network module when the metadata information further includes the alternative source, wherein the alternative source is one of the target devices or a source in an external network. On the other hand, the processor downloads the digital object from the original source through the network module when the metadata information does not include the alternative source.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a hardware diagram of an exemplary electronic device for implementing the method of the present invention.

FIG. 2 illustrates a mesh network architecture according to an embodiment of the present invention.

FIG. 3 illustrates a flowchart of a method for sharing a digital object over a mesh network according to an embodiment of the present invention.

FIG. 4A-4D illustrate tables including metadata information and routing information throughout the distribution of the digital object in the mesh network 200 according to the embodiment of FIG. 3

FIG. 5 illustrates a flowchart of a method for sharing a digital object over a mesh network according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

No element, act, or instruction used in the description of the present application should be construed as absolutely critical or essential to the present disclosure unless explicitly described as such. Also, as used herein, each of the indefinite articles “a” and “an” is intended to exclude more than one item. If only one item is intended, the terms “a single” or similar languages could be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

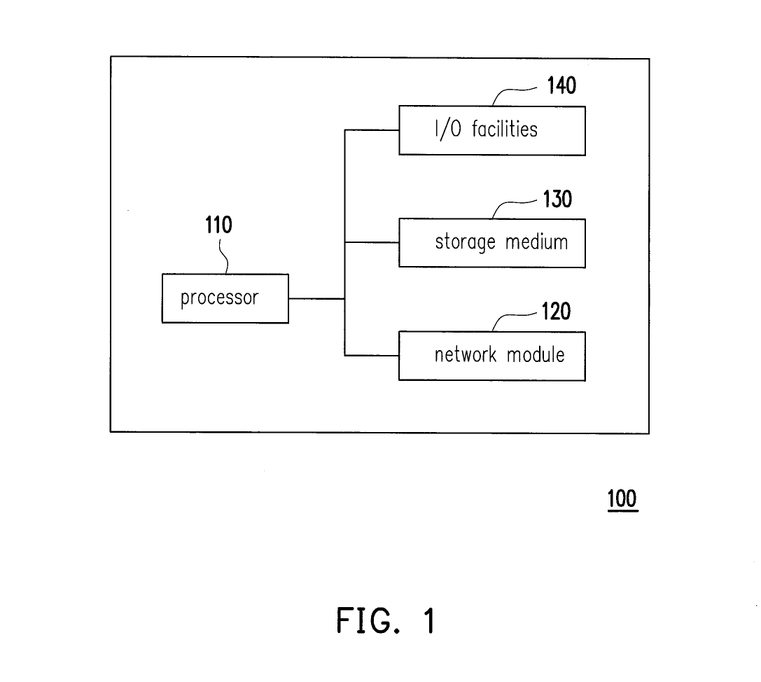

FIG. 1 illustrates a hardware diagram of an exemplary electronic device for implementing the method of the present invention. Referring to FIG. 1, an electronic device 100 may include an internet access feature such as a smart phone according to some embodiments of the disclosure; however, the disclosure is not limited thereto. The electronic device 100 may also be a mobile phone, a personal digital assistant (PDA), a desktop computer, a laptop computer, a tabular computer, a digital camera and so forth.

In the present embodiment, the electronic device 100 may include a processor 110, a network module 120, a storage medium 130, and input/output (I/O) facilities 140. The processor 110 may be electrically coupled to at least but not limited to the network module 120, the storage medium 130, and the I/O facilities 140.

The processor 110 is used for processing all tasks of the exemplary electronic device 100.

The network module 120 may support wireless signal transmissions of at least one of a global system for mobile communication (GSM), a third generation (3G) telecommunication network, a fourth generation (4G) telecommunication network, a long term evolution (LTE) network, a personal handy-phone system (PHS), a code division multiple access (CDMA) system, a wireless fidelity (Wi-Fi) system, a Bluetooth system and a worldwide interoperability for microwave access (WiMAX) system.

The storage medium 130 may be a volatile or non-volatile device known to those skilled in the art including, for example, a static random access memory (SRAM), a dynamic random access memory (DRAM), a flash memory, or a hard disk. The storage medium 130 may include computer program products such as in the form of programming code, routines, or instruction blocks that provide a specific set or sets of ordered operations that control the functionality of the hardware and direct its operation to perform some features or functionality of the electronic device 100.

The I/O facilities 140 may include an interface for a touch screen display, a keyboard, a joystick, a mouse, a pointing device, a speech-based interaction device or the like.

In one of exemplary embodiment, a user may wish to share a file with a social group such as family members, friends, or colleagues. Such file may be music, a video clip, a photograph, a game, and so forth downloaded from a cloud storage system such as a public cloud storage provider or a private cloud storage provider. In other embodiments, the user may just share a file with the social group simply from his/her own electronic device. It is assumed that electronic devices of the user and the social group altogether form a mesh network. The mesh network may be defined as a group of wireless electronic devices capable of communicating directly with one another as well as communicating with a centralized device via a subscriber based wireless data communication network such as 3G network, 4G network, a cellular network, other wireless data communication, or any combination thereof. Each node in the mesh network may not only capture and disseminate its own data, but may also serve as a relay for other nodes; that is, each of the nodes may collaborate to propagate the data in the network. Each of the electronic devices is considered as a node which may exchange information with its nearest neighbors.

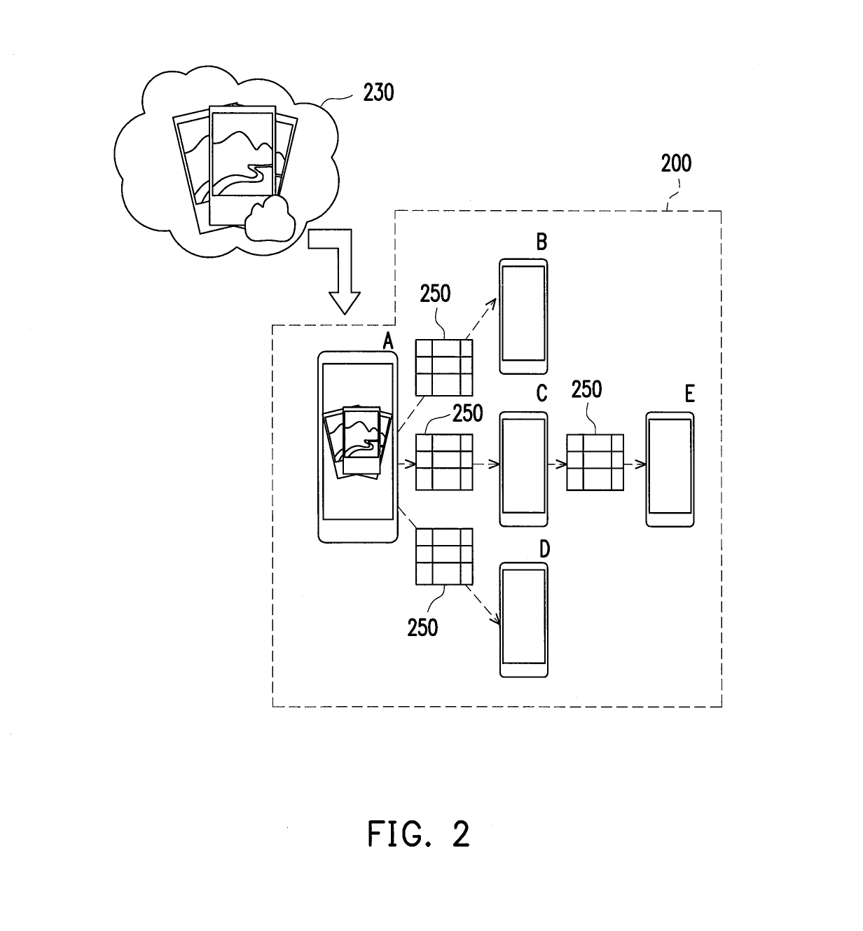

FIG. 2 illustrates a mesh network architecture according to an embodiment of the present invention. Referring to FIG. 2, a mesh network 200 including five electronic devices A, B, C, D, and E, wherein each of the electronic devices A-E is provided with similar components, features and functionality as the electronic device 100 in FIG. 1. In the present embodiment, the mesh network 200 is configured as a proximity-based network with a three-level hierarchical structure. The electronic device A may be served as a root node and share a file in the storage medium 130 or a file downloaded from a cloud storage system 230. The electronic devices B, C, and D are first-level child nodes of the electronic device A, and the electronic device E is a second-level child node of the electronic device A. The electronic device A may give a permission or a prohibition for the electronic devices B-E either manually or by a password code to join in the mesh network 200, detect if any of the target devices B-E leaves from the mesh network 200, and update any change of a status related to the target devices B-E in the mesh network 200, wherein the electronic device A may manage such processes by a table 250 including metadata information and routing information as illustrated in the following embodiments.

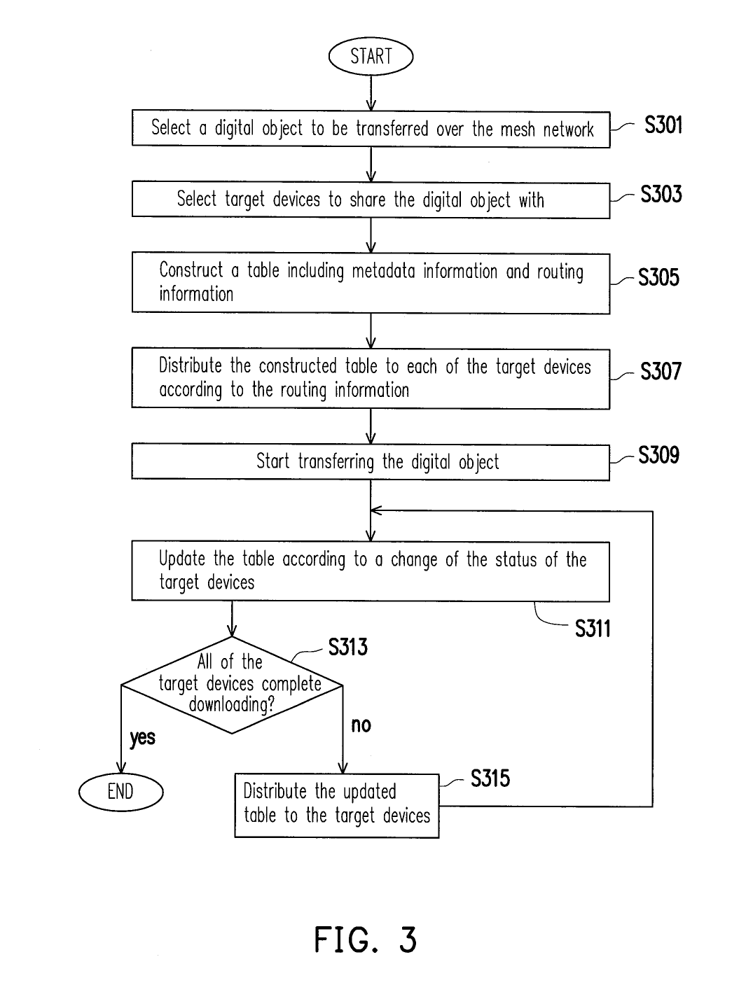

FIG. 3 illustrates a flowchart of a method for sharing a digital object over a mesh network according to an embodiment of the present invention in which several scenarios may be envisioned. Referring to FIG. 3 along with the mesh network 200 in FIG. 2 and the components in FIG. 1, the electronic device A, defined as the root node, is referred to as a group owner A. It is noted that the method in the present embodiment is executed by the group owner A. Furthermore, only a single digital object, such as a file, is shared among four electronic devices B-E in the following embodiments for purposes of clarity and ease of explanation unless otherwise specified. First, the group owner A selects a digital object to be transferred over the mesh network 200 (Step S301). Next, the group owner A may select electronic devices to share the digital object with (Step S303). In the present embodiment, the electronic devices B-E, referred to as target devices B-E, are selected. The group owner A may give a permission for each of the target devices B-E to join the mesh network 200 either manually or by an automated password authentication.

The processor 110 of the group owner A may configure the mesh network 200 as a proximity-based network with a three-level hierarchical structure as illustrated in FIG. 2. In other words, the architecture of the mesh network 200 is arranged according to the proximity of the target devices B-E with respect to the group owner A. Once the mesh network 200 is formed, the processor 110 of the group owner A may construct a table including metadata information and routing information (Step S305).

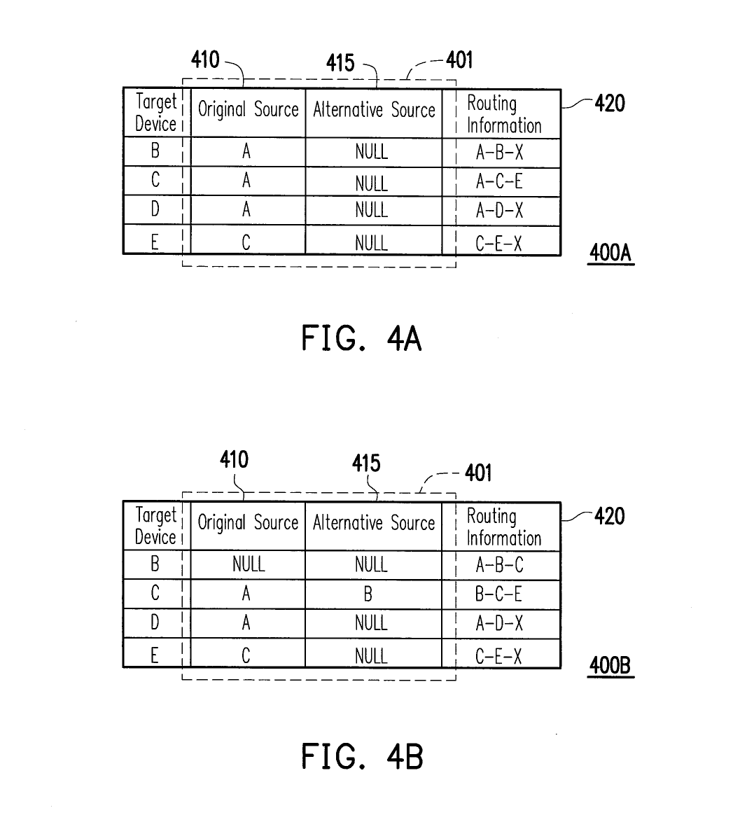

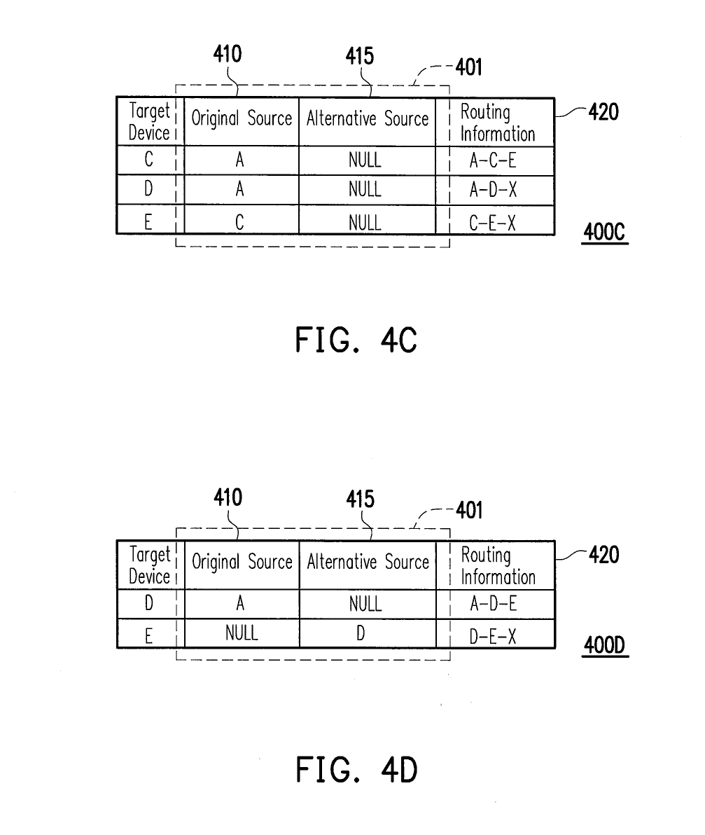

FIG. 4A-4C illustrate tables including metadata information throughout the distribution of the digital object in the mesh network 200 according to the embodiment of FIG. 3. Referring to FIG. 4A, a table 400A includes metadata information 401 and routing information 420 of the digital object in the mesh network, wherein the metadata information 401 includes at least but not limited to an original source 410 and an alternative source 415.

For each of the target devices B-E, the original source 410 of the digital object herein refers to as the electronic device in the mesh network which may provide the digital object for the corresponding target device to download. The alternative source 415 of the digital object refers to as a source other than the original source 410 which may also provide the digital object for the corresponding target device to download. The routing information 420 represents a path of the digital object and includes three components. The first component represents the electronic device from which the corresponding target device may download the digital object; the second component represents the corresponding target device; the third component represents the electronic device to which the corresponding target device may need to send the digital object. Loosely speaking, the routing information of each of the target devices B-E includes a download source (the previous node), the corresponding target device (the current node), and a destination (the next node). In the mesh network 200, the processor 110 of the group owner A may forward the table and the digital object to the target devices B-E directly or indirectly according to the routing information 420. On the other hand, the processors 110 of the target devices B-E may forward the table among the target devices B-E themselves according to the routing information 420 as well. In the present embodiment, the original source 410 of each of the target devices B-D is initially set as the group owner A, and the routing information 420 of each of the target devices B-D is initially set as “A-B-X”, “A-C-E”, and “A-D-X” respectively, wherein X represents a null destination. On the other hand, due to the proximity-based networking architecture, the original source 410 of the target device E is assigned to the target device C by default, and the routing information 420 of the target device E is set as “C-E-X”. In the present embodiment, since the group owner A is the only distributor at this moment, there is no alternative source available. The alternative source 415 of each of the target devices B-E is set as “NULL”.

Referring back to FIG. 3, after the processor 110 of the group owner A constructs the table 400A, the network module 120 of the group owner A may distribute the constructed table 400A to each of the target devices B-E according to the routing information 420 in the table 400A (Step S307). The group owner A may forward the constructed table 400A directly or indirectly to each of the target devices B-E by traversing along the path according to the corresponding routing information 420. For example, the group owner A may forward the constructed table 400A directly to the target devices B-D, and the target device C may forward the constructed table 400A directly to the target device E. Next, the network module 120 of the group owner A starts transferring the digital object to the assigned destinations, which are the target devices B, C, and D, in a similar fashion (Step S309). It is noted that, the main goal of the present invention is to offload the traffic from the group owner A as well as the original source, and therefore each of the target devices B-E may first check if there is any alternative source available according to the alternative source 415 in the table 400A.

The processor 110 of the group owner A may update the table 400A according to any change of a status of each of the target devices B-E (Step S311). For example, in one scenario, FIG. 4B is an updated table of the table 400A after a change of the status of the target devices. Referring to FIG. 4B, after the target device B finishes downloading the digital object, the network module 120 of the target device B may send a report to the group owner A by traversing the path reversely according to the corresponding routing information 420. After being notified, the processor 110 of the group owner A may update the original source 410 of the target device B to “NULL”, which represents a null original source. Furthermore, since the target device C is the nearest device to the target device B, the processor 110 of the group owner A also sets the target device B as the alternative source of the target device C in the metadata information. The routing information 420 of the target device B may be updated to “A-B-C” and the routing information of the target device C may be updated to “B-C-E”.

Referring back to FIG. 3, after the processor 110 of the group owner A updates the table 400A to the table 400B, the processor 110 of the group owner A may check if all of the target devices B-E complete downloading the digital object (Step S313). In one of exemplary embodiment, the processor 110 of the group owner A may determine if the original source corresponding to each of the target devices B-E is set as “NULL”. If all of the target devices B-E complete downloading the digital object (i.e. the original source of each of the target devices B-E is set as “NULL”), the processor 110 of the group owner A may end the process for sharing the digital object; if not, the network module 120 of the group owner A may distribute the updated table 400B to the target devices B-E according to the routing information 420 (Step S315).

For the target devices that have not yet finished downloading the digital object, each of such target devices continues downloading the digital object according to the metadata 401 in the updated table 400B. In this case, the network module 120 of the target device B may start transferring the digital object to the target device C. In the mean time, the target device D may still continue downloading the digital object from the group owner A, and the target device E may still wait for the target device C to transfer the digital object. The processor 110 of the group owner A may repeat Step S311 whenever the change of the status of the target devices occurs. In another exemplary embodiment, the network module 120 the target device C may also start transferring a downloaded portion of the digital object to the target device E even when the target device C has not yet completed the downloading process from the group owner A. The target devices C and E may download the digital object almost concurrently in this way.

In another scenario, FIG. 4C is an updated table 400C of the table 400B after another change of the status of the target devices. Referring to FIG. 4C, it is assumed that the target device B leaves the mesh network 200 after finishes downloading the digital object. The processor 110 of the group owner A may first delete the entire row corresponding to the target device B from the table 400B as well as delete the alternative source 415 of the target device C from the metadata information 401. In this case, the alternative source 415 of the target device C may be reset as “NULL” by the processor 110 of the group owner A due to the departure of the target device B. The target device C may continue downloading the digital object from its original source 410, which is the group owner A, and the routing information 420 of the target device C may be set as “A-C-E”.

In another scenario, FIG. 4D is an updated table 400D of the table 400C after another change of the status of the target devices. Referring to FIG. 4D, it is assumed that the target device C leaves the mesh network 200 after finishes downloading the digital object. The processor 110 of the group owner A may first delete the entire row corresponding to the target device C from the table 400C and delete the target device C from the routing information 420. In this case, the original source 410 of the target device E may be reset as “NULL” due to the departure of the target device C, and the alternative source 415 of the target device E may be set as the target device D. The routing information 420 of the target device D and E may be set as “A-D-E” and “D-E-X” respectively.

In the present embodiment, it is assumed that only one single object is shared within the mesh network 200. In another exemplary embodiment, after all of the target devices B-E is determined to obtain the digital object in Step S313, if there still exists other digital objects to be shared over the mesh network 200 from the group owner A, the network module 120 of the group owner A may perform Step S309 to start another file transfer process. Otherwise, the processor 110 of the group owner A may end the process for sharing the digital objects. It is noted that, multiple digital objects may also be transferred to the target devices B-E concurrently, and yet the frequency of updating the table may be higher.

Furthermore, the mesh network 200 may not necessarily be proximity-based. In one of exemplary embodiments, the network modules 120 of the group owner A may distribute the table to the target devices B-E through a direct connection, and the target devices B-E may notify any update to the group owner A through the direct connection as well. In this scenario, the routing information is no longer necessary, and the alternative source of each of the target devices B-E may not necessarily be its nearest neighbour. In some embodiments, the alternative source may be a source of the digital object from an external network accessible to some of the target devices. The processor 110 of the group owner A may set the source of the digital object from the external network as the alternative source in the metadata information while constructing the table in Step S305. In such case, each of the target devices with an accessibility of the external network may directly download the digital object from the external network instead of waiting for the previous node (parent node) to share the digital object. By that means, the alternative source may offload the traffic from the original source as well as the entire mesh network 200.

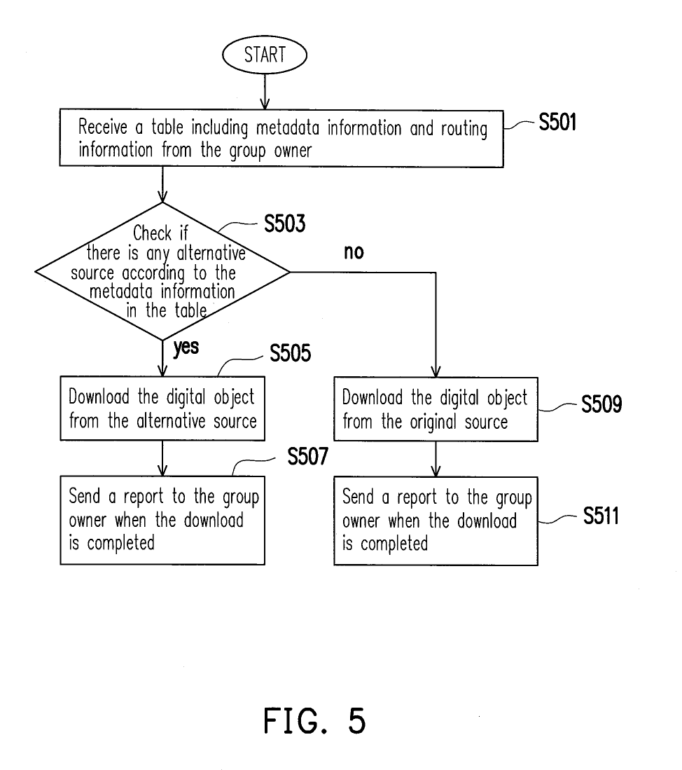

FIG. 5 illustrates a flowchart of a method for sharing a digital object over a mesh network according to another embodiment of the present invention from a viewpoint of each of the target devices B-E. Referring to FIG. 5 along with the mesh network 200 in FIG. 2 and the components in FIG. 1, after the processor 110 of the group owner A constructs a table including metadata information and routing information, the network module 120 of the group owner A distributes the constructed table to each of the target devices B-E according to the routing information in the table. In other words, each of the target devices B-E may receive the table from the group owner A directly or indirectly through the network module 120 of each of the target devices B-E (Step S501). For simplicity, the following description will be focus on the target device C.

The target device C may first check if there is any alternative source to download the digital object according to metadata information in the table (Step S503). If there exists an alternative source for the target device C, the target device C may download the digital object from the alternative source through the network module 120 of the target device C (Step S505). Once the target device C completes the download, its processor 110 may send a report to the group owner A through the network module 120 of the target device C (Step S507), wherein the report indicates that the target device C also owns the digital object. That is, the group owner A may be notified that the target device C may be an alternative source for other target devices B, D, and E. The group owner A may further update the table according to Step S311.

On the other hand, if the target device does not have any alternative source, it may download the digital object from the original source through the network module 120 (Step S509). Once the target device C completes the download, its processor 110 may also send a report to the group owner A through the network module 120 (Step S511), wherein the report indicates that the target device C also owns the digital object. The group owner A may further update the table according to Step S311 in a similar fashion.

In view of the aforementioned descriptions, the method and the device provided in the present disclosure is able to share a digital object efficiently over a mesh network. A group owner may construct and maintain a table including metadata information when the digital object has been created, received or downloaded. A network module of the group owner may further distribute the metadata information to each target device and provide more efficient routing method. By leveraging the proposed method in the aforementioned embodiments, the group owner is able to keep track of the status and the routing information of the target devices in the mesh network during proximity-based P2P data transfer. Accordingly, the speed of file transfer among the mobile communication devices over a network may be optimized with limited bandwidth.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for sharing a digital object over a mesh network comprising a group owner and a plurality of target devices, wherein the method is executed by the group owner and the method comprises:
constructing a table comprising metadata information, wherein the metadata information comprises an original source of the digital object in the mesh network;
distributing the table to each of the target devices, wherein each of the target devices downloads the digital object according to the metadata information;
updating the table according to a change of a status of the target devices; and
distributing the updated table to each of the target devices.

2. The method of claim 1, wherein the metadata information further includes an alternative source for a first target device of the target devices, and wherein the first target device downloads the digital object from the alternative source.

3. The method of claim 2, wherein the alternative source is a source of the digital object in an external network.

4. The method of claim 2, wherein the change of the status comprises that a second target device of the target devices just finished downloading the digital object and the step of updating the table comprises:
adding the second target device as the alternative source into the metadata information.

5. The method of claim 4, wherein the second target device is the target device nearest to the first target device that owns the digital object.

6. The method of claim 4, wherein the change of the status comprises that the second target device leaves the mesh network and the step of updating the table comprises:
deleting the alternative source from the metadata information.

7. The method of claim 1, wherein the mesh network is a proximity-based mesh network and the table further comprises routing information, and wherein the target devices forward the table and the digital object among themselves according to the routing information.

8. The method of claim 7, wherein the change of the status comprises that a third target device of the target devices leaves the mesh network and the step of updating the table comprises:
deleting the third target device from the routing information.

9. A method for sharing a digital object over a mesh network comprising a group owner and a plurality of target devices, wherein the method is executed by a first target device of the target devices and the method comprises:
receiving a table from the group owner, wherein the table comprises metadata information and the metadata information comprises an original source of the digital object in the mesh network;
downloading the digital object from an alternative source when the metadata information further comprises the alternative source, wherein the alternative source is a second target device of the target devices or a source in an external network; and
downloading the digital object from the original source when the metadata information does not comprise alternative source.

10. The method of claim 9, further comprising:
sending a report to the group owner indicating that the first target device already owns the digital object when the download of the digital object is finished.

11. The method of claim 9, wherein the mesh network is a proximity-based mesh network and the table further comprises routing information, and wherein the first target device forwards the table to the other target devices according to the routing information.

12. An electronic device for sharing a digital object over a mesh network comprising the electronic device and a plurality of target devices, wherein the electronic device comprises:
a processor, constructing a table comprising metadata information and updating the table according to a change of a status of the target devices, wherein the metadata information comprises an original source of the digital object in the mesh network; and
a network module, coupled to the processor, distributing the constructed table and the updated table to each of the target devices, wherein each of the target devices downloads the digital object according to the metadata information.

13. The electronic device of claim 12, wherein the metadata information further includes an alternative source for a first target device of the target devices and the first target device downloads the digital object from the alternative source.

14. The electronic device of claim 13, wherein the alternative source is a source of the digital object in an external network.

15. The electronic device of claim 13, wherein the change of the status comprises that a second target device of the target devices just finished downloading the digital object and the processor updates the table by adding the second target device as the alternative source into the metadata information.

16. The electronic device of claim 15, wherein the second target device is the target device nearest to the first target device that owns the digital object.

17. The electronic device of claim 15, wherein the change of the status comprises that the second target device leaves the mesh network and the processor updates the table by deleting the alternative source from the metadata information.

18. The electronic device of claim 12, wherein the mesh network is a proximity-based mesh network and the table further comprises routing information, and wherein the target devices forward the table among themselves according to the routing information.

19. The electronic device of claim 18, wherein the change of the status comprises that a third target device of the target devices leaves the mesh network and the processor updates the table by deleting the third target device from the routing information.

20. An electronic device for sharing a digital object over a mesh network comprising a group owner and a plurality of target devices, wherein the electronic device is one of the target devices and the electronic device comprises:
a network module; and
a processor, coupled to the network module, receiving a table from the group owner through the network module, wherein the table comprises metadata information and the metadata information comprises an original source of the digital object in the mesh network, wherein the processor downloads the digital object from an alternative source through the network module when the metadata information further comprises the alternative source, wherein the alternative source is one of the target devices or a source in an external network, wherein the processor downloads the digital object from the original source through the network module when the metadata information does not comprise alternative source.

21. The electronic device of claim 20, wherein the processor sends a report to the group owner indicating that the electronic device already owns the digital object when the download of the digital object is finished.

22. The electronic device of claim 20, wherein the mesh network is a proximity-based mesh network and the table further comprises routing information, and wherein the processor forwards the table to the other target devices according to the routing information.
